(19) United States
(12) Patent Application Publication
(10) Pub. No.: US 2008/0197662 A1
(43) Pub. Date: Aug. 21, 2008

(54) Loading space for a motor vehicle, with a protective device

(76) Inventor: Marina Ehrenberger, Esslingen (DE)

Correspondence Address: FLYNN THIEL BOUTELL & TANIS, P.C., 2026 RAMBLING ROAD, KALAMAZOO, MI, 49008-1631, US

(21) Appl. No.: 11/786,374

(22) Filed: Apr. 11, 2007

(30) Foreign Application Priority Data
Apr. 11, 2006 (DE) 10 2006 018079.8

(51) Int. Cl. B60P 7/02

(52) U.S. Cl. 296/98

(57) ABSTRACT

A loading space for a motor vehicle, with a protective device which comprises a flexible sheetlike structure for holding back a load and has a dimensionally stable housing unit which is held releasably in mounts on the loading space side, is known.

According to the invention, means are provided for transferring the housing unit into a securing position, which is connected with a form fit to mounts on the loading space side, as a function of a tensile or flexural loading acting on the sheetlike structure.

Use for passenger vehicles.

The invention relates to a loading space for a motor vehicle, with a protective device which comprises a flexible sheetlike structure for holding back a load and has a dimensionally stable housing unit which is held releasably in mounts on the loading space side, and to a protective device for a motor vehicle interior, in particular a loading space of this type.

Separating devices, which serve as protective devices, for loading spaces of passenger vehicles are known in general. A separating device of this type has a flexible sheetlike structure in the form of a separating net which is held in a manner such that it can be wound up and unwound on a winding shaft. The winding shaft is mounted rotatably in a cassette housing which extends between opposite sides of the loading space approximately level with a vehicle window-base edge and is fastened in mounts on the loading space side. In its protective position, the separating net is extended upward to a roof lining and is suspended in the region of the roof lining such that the separating net extends approximately vertically upwards. The separating net serves to hold back a load, which is located in the loading space, in the loading space in the event of a severe deceleration of the vehicle thus to prevent the load from being hurled forwards into the passenger compartment. The cassette housing is locked releasably in the mounts on the vehicle side by fastening mechanisms which are designed and are operable in a complicated manner. In order to be able to remove the cassette housing, the fastening mechanisms have to be released.

It is the object of the invention to provide a loading space of the type mentioned at the beginning, which is provided with a protective device which is operable easily and nevertheless has a reliable protective function.

This object is achieved in that means are provided for transferring the housing unit into a securing position, which is connected with a form fit to the mounts on the loading space side, as a function of a tensile or flexural loading acting on the sheetlike structure. According to the invention, when the sheetlike structure is subjected to an appropriate loading, the housing unit is inevitably transferred into the securing position which is locked with a form fit to the mounts on the loading space side. In this case, either the housing unit itself can be displaced slightly, or the housing unit comprises at least one securing element which is transferred as a function of the tensile or flexural loading acting on the sheetlike structure into a securing position locked with a form fit to the respective mount on the loading space side. It is also possible to provide correspondingly movable securing elements on the loading space side, which are coupled to the movement of the sheetlike structure in such a manner that, upon appropriate loading, they are transferred from the inoperative position into the securing position which is connected with a form fit to the housing unit. The form-fitting connection is based on the axial direction of the winding axis of the winding shaft. The essential idea of the invention is to provide a form-fitting connection of the housing unit to the mounts on the loading space side only for the situation in which the sheetlike structure is transferred into its protective position or, if already in its protective position, is loaded by a load held into it. The housing unit can therefore be used in an extremely simple manner in the region of the mounts on the loading space side or removed if the sheetlike structure is in its inoperative position wound up onto the winding shaft. In an advantageous manner, it is possible to provide the housing unit with housing side parts between which the winding shaft is mounted rotatably, with at least one housing side part being arranged displaceably coaxially with or axially parallel to the axis of rotation of the winding shaft in order to simplify a release of the housing unit from or insertion of it into the mounts on the loading space side. Depending on the configuration of the housing side parts and of the winding shaft, an encapsulation of the winding shaft between the housing side parts by means of a corresponding housing part may be omitted. The forces are then transmitted via the winding shaft.

If the means for transferring the housing unit into a securing position are assigned to the winding shaft, the housing unit itself does not have to be designed to be sufficiently stable such that it can absorb corresponding forces, as is the case with known cassette housings which can be fastened in mounts on the loading space side by means of fastening mechanisms which are effective with a form fit.

In a refinement of the invention, the transferring means have, in the region of the mounts on the loading space side, profiled guide structures which, starting from an unloaded fastening position of the housing unit, are set in the direction of a deflection movement of the housing unit during a tensile or flexural loading on the sheetlike structure, and guide elements are provided on the housing unit and are designed in a manner corresponding to the profiled guide structures such that, upon a deflection movement of the housing unit, they enter the profiled guide structures and engage behind the latter with a form fit along an axis of rotation of a winding shaft for winding up and unwinding the sheetlike structure. The profiled guide structures are preferably designed as slots in the region of the mounts on the loading space side, and the guide elements are advantageously designed as pins which are arranged in the region of opposite ends of the housing unit and enter the profiled guide structures. It is also possible to provide pin- or web-like profiles as profiled guide structures in the region of the mounts on the loading space side and, accordingly, to configure the guide elements on the housing side with the form of grooves or receptacles.

In a further refinement of the invention, the profiled guide structures are configured as slotted-guide mechanisms which are set in the vertical direction of the vehicle, and the guide elements are designed as guide pins, which protrude along the axis of rotation of the winding shaft, are provided with a thickened head and the diameter of which is matched to the slotted-guide mechanisms in such a manner that the guide pins are displaced in a sliding manner in the slotted-guide mechanisms. The guide pins are preferably mounted movably in an extension of the axis of rotation of the winding shaft. In addition, it is possible for the guide pins to be designed such that they are rotatable about a certain pivoting angle.

In a further refinement of the invention, the means for transferring the housing unit into a form-fitting securing position comprise at least one securing element, which is assigned to the housing unit and is arranged removably with respect to the housing unit between a locked and an unlocked position, the securing element being operatively connected via a constrained coupling mechanism to a winding shaft, on which the flexible sheetlike structure is held in a manner such that it can be wound up and unwound, in such a manner that, upon a rotational movement of the winding shaft, the securing element is transferred into its locked or its unlocked position as a function of the direction of rotation. In this embodiment, the housing unit remains in a stationary position. In order nevertheless to permit locking of the housing unit in the mounts on the loading space side using simple means, the movement of at least one securing element between an unlocked and a locked position is advantageously coupled to a pulling-out or drawing-in movement of the sheetlike structure. The housing unit is therefore inevitably blocked in its position on the loading space side as soon as the sheetlike structure is pulled out and suspended in its stretched-out protective position. In a correspondingly converse manner, the locking of the housing unit is automatically released as soon as the sheetlike structure is released from its stretched-out protective position and is wound up again within the housing unit. The housing unit may be designed as a dimensionally stable cassette housing. The housing unit advantageously merely comprises two cup-like housing side parts between which the winding shaft together with the wound-up sheetlike structure essentially freely extends. In this embodiment, a complicated cassette housing which is closed over its entire length is not required. The winding shaft and therefore the opposite housing side parts are advantageously each assigned a securing element, the movement of which is synchronized via the pulling-out or drawing-in movement of the sheetlike structure and therefore via the corresponding rotational movement of the winding shaft.

In a further refinement of the invention, the constrained coupling mechanism comprises a movement transmission element which is coupled to the rotational movement of the winding shaft and is provided with a constrained guide which acts on the securing element in such a manner that, upon a rotational movement of the winding shaft, the securing element is transferred into its locked or unlocked position. This embodiment involves a mechanical constrained coupling which is particularly robust and functionally reliable.

In a further refinement of the invention, the securing element can be rotated by means of the constrained guide in a limited manner between the locked and the unlocked position about an angle of rotation unequal to a half or a full revolution. This refinement ensures that the securing element is rotated sufficiently far for it to be in a different orientation in the different end positions. The securing element itself has to be designed in a rotationally asymmetrical manner, in particular in the manner of a T, in the region of its head in order to realize the various positions. In an advantageous manner, the securing element can be rotated through 90° and has a T-like head which, in one position, is aligned with a corresponding guide groove of the profiled guide structure on the loading space side and, in the other position, is oriented transversely with respect to the guide groove.

In a further refinement of the invention, the constrained guide comprises a helical guide groove which runs coaxially with the axis of rotation of the winding shaft and in which a slotted-guide pin connected in a rotationally fixed manner to the securing element is guided. The guide groove is preferably provided in a guide sleeve which is oriented coaxially with the axis of rotation of the winding shaft. The helical guide groove including the sleeve part in which it is formed is jointly rotatable together with the winding shaft. The securing element is firstly axially movable in an extension of the axis of rotation of the winding shaft in order to permit the securing element to enter the guide groove. Secondly, the securing element is additionally rotated during its axial movement by the corresponding constrained guide about the limited angle of rotation in order to obtain the locking in the guide groove.

In a further refinement of the invention, the constrained guide comprises a driver disk which is rotationally fixed to the winding shaft and acts non-positively or with a form fit on a driver pin connected in a rotationally fixed manner to the securing element. Rotation of the winding shaft causes rotation of the driver disk which, during its rotational movement, carries along the driver pin to a limited extent in a non-positive or frictional manner such that the desired limited rotation of the securing element is achieved.

In a further refinement of the invention, the securing element is assigned energy absorption means which act in an energy-converting manner between securing element and housing unit in the event of loadings caused by a vehicle impact. Corresponding kinetic energy between securing element and housing unit is preferably converted into deformation energy by the energy absorption means being plastically deformed. For this purpose, the energy absorption means particularly preferably comprise at least one plastically deformable buffer element.

Further advantages and features of the invention emerge from the claims and from the description below of preferred exemplary embodiments of the invention, which are illustrated with reference to the drawings, in which

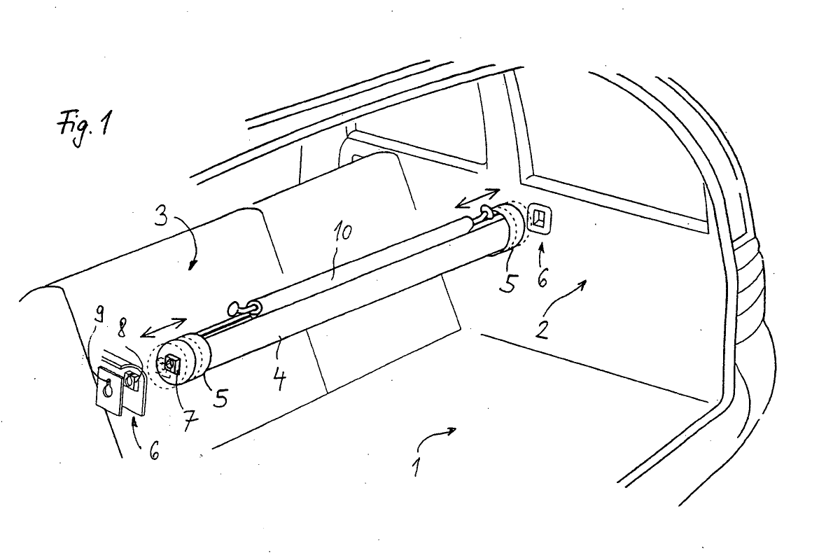

FIG. 1 shows schematically, in a perspective illustration, a loading space of a motor vehicle, which is provided with a protective device,

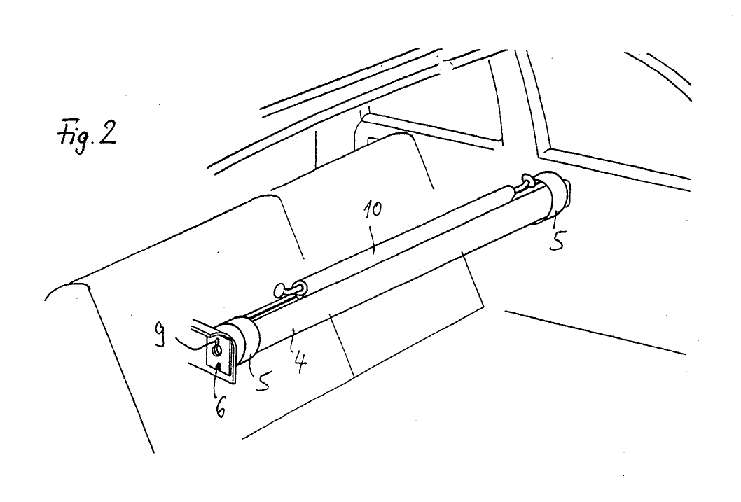

FIG. 2 shows the protective device according to FIG. 1 in its position fitted on the loading space side,

FIG. 3 shows the protective device according to FIGS. 1 and 2 with a flexible sheetlike structure pulled out upwards,

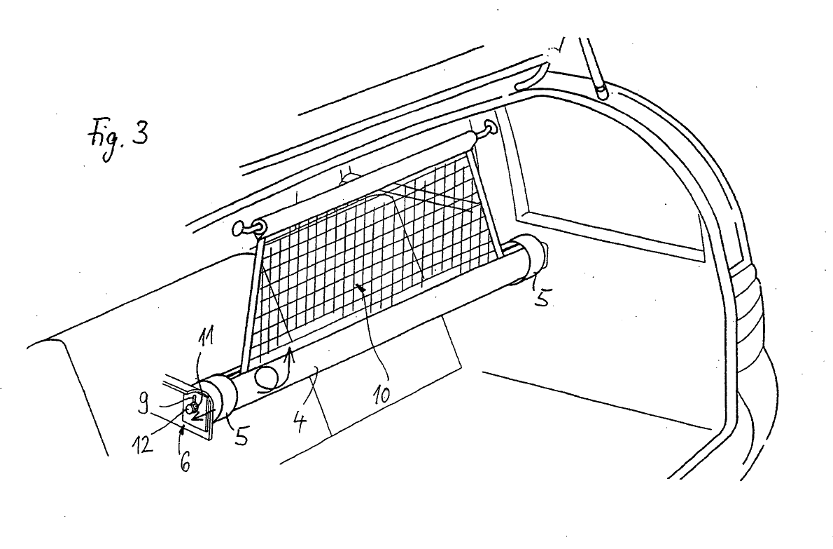

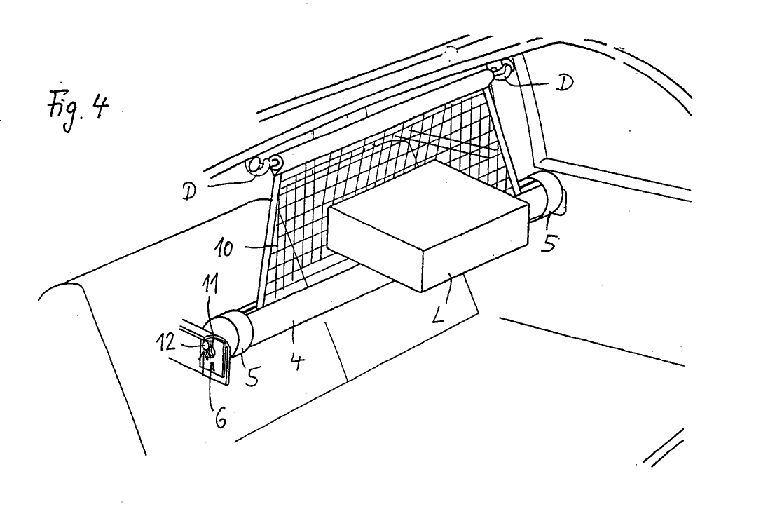

FIG. 4 shows the protective device according to FIGS. 1 to 3 in its protective position in which the flexible sheetlike structure holds back a load in the loading space,

FIG. 5 shows a further embodiment of a protective device for a loading space according to the invention, the protective device being illustrated in a non-fitted position,

FIG. 6 shows the protective device according to FIG. 5 in a fitted functional position secured on the loading space side,

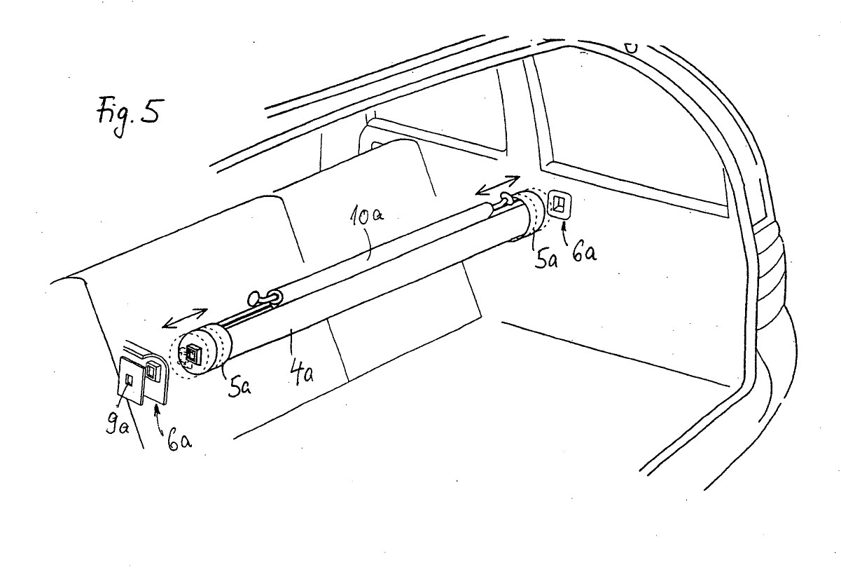

FIG. 7a shows a detail of the mount, on the loading space side, of the protective device according to FIGS. 5 and 6,

FIG. 7b shows, in a schematic longitudinal sectional illustration, a detail of the protective device according to FIGS. 5 and 6 in a fitted position,

FIG. 8a shows the mount on the loading space side according to FIG. 7a, in which a securing element of the housing unit of the protective device is transferred into its locked position,

FIG. 8b shows, illustrated schematically in a longitudinal section, a part of the protective device according to FIGS. 5 and 6 in its protective position locked on the loading space side,

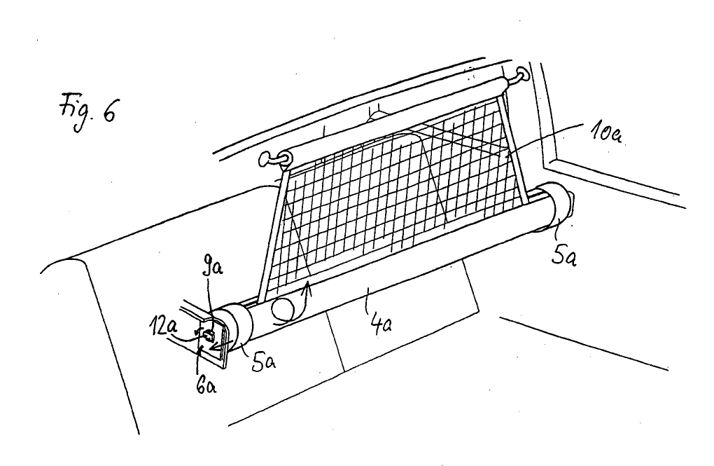

FIG. 9a shows, in an enlarged, perspective illustration, a partial region of the protective device according to FIGS. 7b and 8b,

FIG. 9b shows the partial region according to FIG. 9a, in which a securing element of the housing unit is transferred into an axially outwardly displaced position,

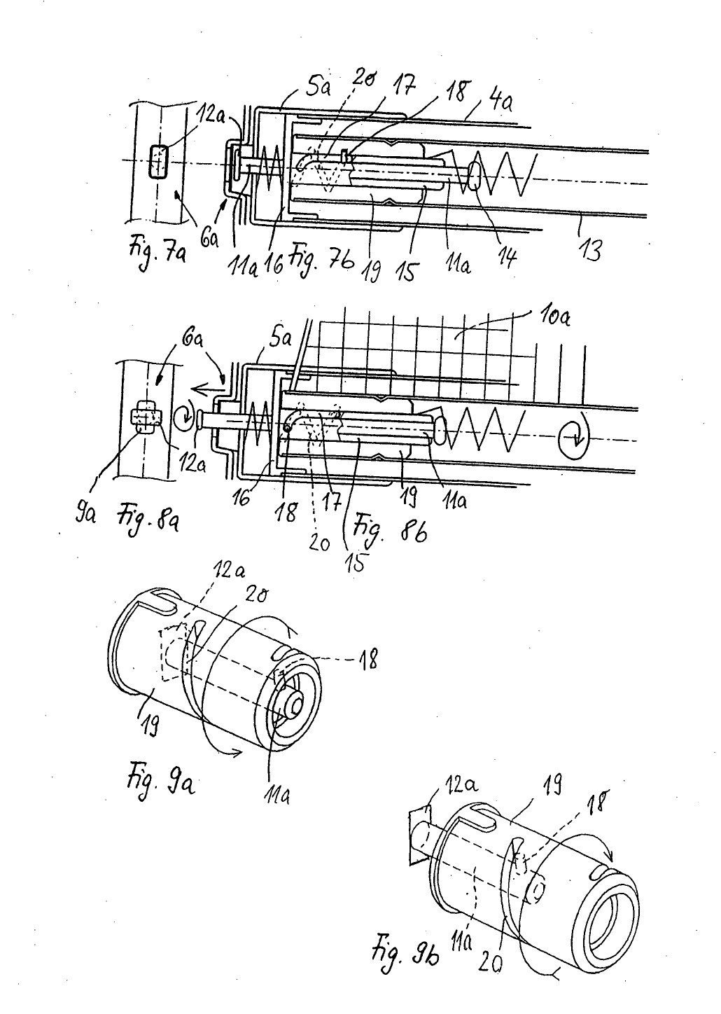

FIGS. 10 to 12 show a further embodiment of a protective device, in which the securing element of the housing unit can be transferred by a driver disk into the locking position, and

FIG. 13 shows, schematically, an additional function of the embodiment according to FIGS. 10 to 12, which function contributes to the absorption of energy in the event of a crash.

FIGS. 1 to 4 illustrate a loading space 1 of a passenger vehicle, in particular an estate vehicle, a large-capacity saloon or an SUV, which can be closed to the rear by a tail gate (not referred to specifically). On opposite sides of the vehicle, the loading space 1 is delimited by two loading space side walls 2. To the front in the normal direction of travel, the loading space 1 is delimited by a backrest arrangement 3 of a rear seat bench. The backrest arrangement 3 can be folded over in a single- or multi-part design, as can be seen in FIGS. 1 to 4. The loading space 1 is assigned a protective device which is described in more detail below and can be fitted just below a vehicle window-base edge in mounts 6 on the loading space side in the region of the opposite loading space side walls 2.

The protective device has a cassette housing 4, 5 which serves as the housing unit within the meaning of the invention and is formed by a cassette profile 4 and two housing side parts 5. The two housing side parts 5 are of cup-like design and are arranged in a longitudinally displaceable manner to a limited extent relative to the cassette profile 4, as shown by the dashed illustration and the double arrows in FIG. 1. A winding shaft, on which a flexible sheetlike structure in the form of a separating net 10 is held in a manner such that it can be wound up and unwound, is mounted rotatably in the cassette housing.

In order to fit the cassette housing 4, 5 in the mount 6 on the loading space side, cam-like formations are provided on the end sides of the housing side parts 5 and enter in corresponding receptacles 8 of the mounts 6 on the loading space side. The two housing side parts 5 are acted upon by spring force axially outwards along an axis of rotation of the winding shaft such that the housing side parts 5 are pressed with their formations 7 into the receptacles of the mounts 6 on the vehicle side.

In the event of a crash, in particular a side crash, the housing side parts 5 would be pressed out of the mounts 6 on the loading space side, and therefore the protective device could be hurled around freely in the vehicle interior. Since the vehicle interior is formed not only by the loading space 1 but also by the passenger compartment containing the rear seat bench, considerable risks of injury to vehicle occupants could occur. Also in the event of a load being hurled into the separating net 10 which is stretched-out vertically upwards, the cassette housing could be torn out of the mounts 6 on the loading space side.

In order, in the event of a crash or in the event of severe decelerations of the vehicle, during which a load is hurled into the separating net 10, to avoid the cassette housing 4, 5 being released from the mounts on the loading space side, the opposite housing side parts 5 are assigned additional securing means which are described in more detail below. The securing means comprise pin-like securing elements 11, 12 which are mounted in an axially movable manner coaxially with the axis of rotation of the winding shaft in the region of opposite ends of the winding shaft. As is indicated with reference to FIG. 3, the securing element 11, 12 is displaced axially outward as a function of a pulling-out movement of the separating net 10 upwards into a securing position. A constrained coupling mechanism, which can be designed in the manner of the illustration according to FIGS. 9a and 9b, is used for this. The bolt-like securing pin 11, 12 is mounted displaceably for this purpose in an extension, which is designed in the manner of a sleeve, of an end cap of the winding shaft, the end cap being fixedly connected on the end side to the cassette profile 4 and therefore being held in a stationary manner relative to the rotatable winding shaft. The end cap with integrally formed sleeve-like extension for the sliding mounting of the securing pin 11, 12 can be designed in accordance with the illustration according to FIGS. 7b and 8b.

At its free end, the securing pin has a widened head 12 which is configured in the manner of a plate. The constrained coupling of the rotational movement of the winding shaft to a displacement movement of the securing pin takes place via a guide sleeve, which is mounted such that it is rotatable together with the winding shaft and in which a helical guide groove is provided analogously to FIGS. 9a and 9b. The securing pin 11, 12 itself has a radially protruding slotted-guide pin or driver pin which enters the guide groove. A rotational movement of the winding shaft therefore inevitably leads to a worm-like advancing of the securing pin 11, 12 and therefore to a displacement movement, if appropriate coupled to a rotational movement of the securing pin 11, 12.

At least on one side—if only one securing pin 11, 12 is provided on an end side of the cassette housing 4, 5—the mounts 6 on the loading space side have a passage which is designed in the manner of a keyhole and has an upwardly protruding, narrow slotted-guide groove 9, the width of which is matched to the width of the securing pin 11. A round section of the keyhole-like passage is somewhat larger than the diameter of the plate-like head 12 of the securing pin 11. The keyhole-like passage is provided in an extension of the rectangular receptacles of the particular mount 6 on the loading space side and behind the particular receptacle. The keyhole-like passage is preferably provided in a separate, dimensionally rigid reinforcing part connected in a force-transmitting manner to the vehicle body.

Therefore, according to FIG. 3, when the separating net 10 is pulled out upwards, the at least one securing pin 11, 12 provided on the end side, preferably both securing pins on opposite housing sides is moved axially outwards—by means of the previously described constrained coupling mechanism, with the plate-like head 12 of the securing pin 11, 12 entering the round section of the keyhole-like passage. By this means the housing unit 4, 5 is located in a pre-secured position. Then, according to FIG. 4, as soon as a flexural or tensile loading acts on the separating net 10, which is suspended by its upper pull-out rod in holding receptacles D on the roof side, due to a load L hurled into it, a further pulling-out movement of the separating net 10 is blocked in a fundamentally known manner. As a result, a tensile loading is inevitably exerted upwards onto the cassette housing 4, 5, and therefore the at least one securing pin 11 enters the slotted-guide groove of the keyhole-like passage of the mount 6 on the loading space side (FIG. 4). The plate-like head 12 engages behind the slotted-guide groove with a form fit such that the cassette housing 4, 5 is held back in a corresponding manner with a form fit in the mount 6 on the loading space side. The form-fitting effect of the plate-like head 12 in conjunction with the slotted-guide groove of the keyhole-like passage takes place in the longitudinal direction of the cassette housing 4, 5 and therefore along the winding shaft of the separating net 10 and its axis of rotation.

The embodiment according to FIGS. 5 and 6 and according to FIGS. 7a to 8b essentially corresponds to the previously described embodiment, and therefore, in order to avoid repetitions, reference is made to the description of the previous embodiment. The differences in the embodiment according to FIGS. 5 and 6 and 7a to 8b are discussed below. The substantial difference in the case of the protective device according to FIGS. 5 and 6 and FIGS. 7a to 8b and FIGS. 9a and 9b is that, there, a head 12a has a rotationally asymmetrical shape by being configured rectangularly and in the manner of a T. Accordingly, the head 12a has two long and two short sides. In addition to an axial movement, the securing pin 11a, 12a is additionally also rotated by means of the constrained coupling mechanism 17 to 20 in a constrained manner through 90° so that the rectangular head rotates out of its vertical orientation (FIG. 7a) into a transverse orientation (FIGS. 6 and 8a). The corresponding passage in the region of the mount 6a on the holding space side likewise has a rectangular shape which is matched in its dimensions to the rectangular shape of the head 12a. The rectangular shape of the passage of the mount 6a on the loading space side is oriented in the vertical direction. This means that the short sides of the rectangle extend at the top and bottom and the long sides extend, oriented vertically, between the upper and lower short sides. In the raised position, the rectangular head 12a of the securing pin 11a, 12a can therefore enter through the rectangular passage 9a of the mount 6a on the loading space side. A subsequent rotation through 90° (FIGS. 6 and 8a) inevitably causes form-fitting locking of the securing pin in the mount 6a on the loading space side.

In order to be able to implement the sliding and rotational function of the securing pin 11a, 12a, the cassette profile 4a is provided with an end cap 16 which closes off the cassette profile 4a, which is configured as an open hollow profile, on the end side. The end cap 16 is provided with a sleeve extension 15 which projects coaxially into the winding shaft 13 and in which the securing pin 11a is mounted displaceably coaxially with the axis of rotation of the winding shaft 13 (illustrated by chain-dotted lines). A slotted-guide mechanism 17 is provided in the sleeve extension 15 and extends outwards linearly and axially parallel to the axis of rotation of the winding shaft 13 and is curved at an outer end region over a thread section of approximately one quarter, as can be seen with reference to FIGS. 7b and 8b. The securing pin 11a is provided with a radially protruding driver pin 18 which protrudes outwards through the slotted-guide mechanism 17. In addition, an outer end region of the driver pin 18 is guided in a helical guide groove 20 of a bearing sleeve 19 which forms an end-side mounting of the winding shaft 13 and is connected in a rotationally fixed manner to the winding shaft 13. The bearing sleeve 19 is configured analogously to FIGS. 9a and 9b.

As soon as the separating net 10a situated on the winding shaft 13 is pulled away upwards, the winding shaft 13 is inevitably rotated. At the same time, the bearing sleeve 19 rotates, as a result of which the driver pin 18 is displaced linearly in the slotted-guide mechanism 17 of the sleeve extension 15. When the separating net 10a has virtually reached its pulled-out end position, the driver pin 18 enters the helically curved, outer end section of the slotted-guide mechanism 17 and is rotated through approximately one quarter turn in addition to a superimposed axial movement. As a result, the head 12a is transferred from its vertical orientation into the transverse orientation. At this moment, the head 12a of the securing pin 11a has already penetrated the rectangular passage 9a and therefore the head 12a is rotated through 90° behind the passage 9a and thus brings about a locking of the securing pin in the mount 6a on the loading space side.

When the separating net 10a is released from its pulled-out protective position, a restoring spring (not referred to specifically) of the winding shaft 13 causes a tensile force and therefore a restoring force on the separating net 10a in the winding-up direction, as a result of which the bearing sleeve 19 is also rotated in a correspondingly converse direction of rotation. The driver pin is thereby inevitably guided back again in the slotted-guide mechanism 17, as a result of which first of all the head 12a is moved again into its vertical orientation and subsequently is moved out of the passage 9a in the direction of the housing unit.

In the embodiment according to FIGS. 10 to 13, a sleeve extension is integrally formed as one piece on a housing side part 5b in a manner such that it protrudes inwards coaxially with the axis of rotation of the winding shaft 13b, and the securing pin 11b, 12b is mounted rotationally to a limited extent, but not slidably, in it. The housing side part 5b is mounted displaceably in the arrow direction (FIGS. 10, 11) relative to the winding shaft 13b, with the housing side part 5b, in the unloaded initial position, being pressed into its axially outer end position (FIG. 11) by a compression spring arrangement. The sleeve extension 15b and therefore the housing side part 5b mounted slidably in a bearing sleeve 19b of the winding shaft 13b, the bearing sleeve 19b being connected in a rotationally fixed manner to the winding shaft 13b. By contrast, the sleeve extension 15b and the housing side part 5b are arranged such that they are merely slidable axially but are not rotatable. The securing pin 11b, 12b has a radially outwardly protruding driver pin 18b which protrudes outwards through a guide groove 22 provided radially over a quarter circle in the sleeve extension 15b. The guide groove 22 extends radially approximately over a quarter of the circumference of the sleeve extension 15b such that a limited rotatability of 90° can be obtained for the securing pin 11b, 12b.

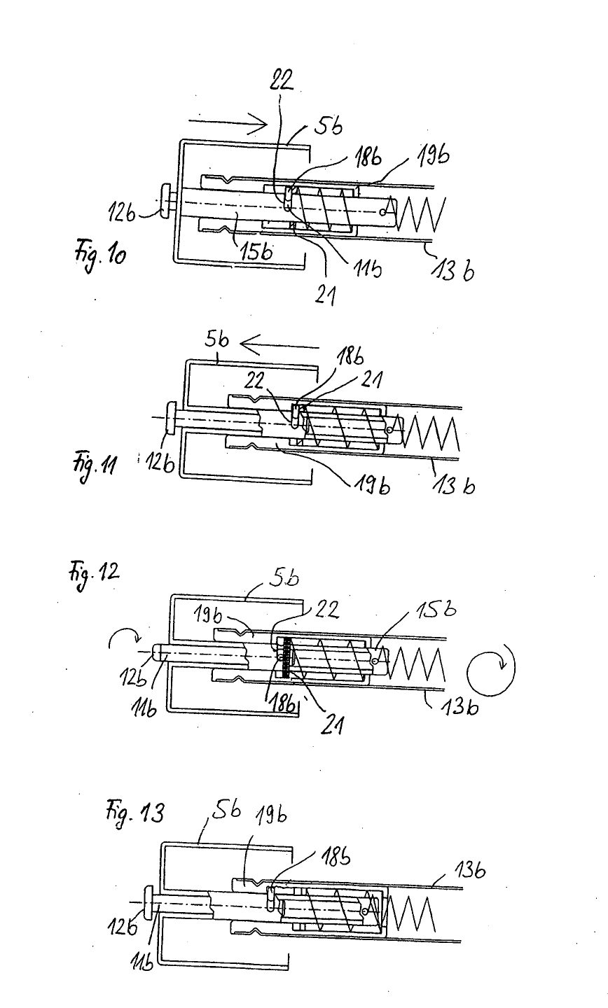

In order to bring about a rotation of the securing pin 11b, 12b, the driver pin 18b is assigned a driver ring 21 which is arranged rotatably on the sleeve extension 15b and, in addition, is arranged in an axially displaceable manner in an axial annular space of the bearing sleeve 19b. The compressive force of a helical compression spring, which is illustrated in FIGS. 10 to 13 but is not referred to in more detail, acts on the driver ring 21. The helical compression spring presses the driver ring 21 against the free end of the driver pin 18b protruding through the guide groove 22, with the frictional forces sufficing in order to cause the driver pin 18b to move out of the upright position according to FIG. 11 into the rotated position according to FIG. 12 during a corresponding pulling-out movement of the winding shaft 13b and of the sheetlike structure located thereon. As a result, the head 12b, which is configured in a T shape or rectangularly, inevitably rotates such that, analogously to the embodiment according to FIGS. 5 and 6 and 7a to 8b, the securing pin 11b is locked in the corresponding mount on the loading space side when the sheetlike structure is pulled out into its protective position. In a correspondingly converse manner, the head 12b is rotated back again into its release position as soon as the sheetlike structure is drawn in again into its wound-up inoperative position. The preassembly in the mounts on the loading space side takes place in a simple manner by an axial, inwards sliding of the at least one housing side part 5b, the orientation of the housing side parts 5b relative to the mounts on the loading space side and the subsequent release of the housing side parts, as a result of which they are pressed outwards and the heads 12b of the securing pins 11b, 12b enter the corresponding passages.

As can be seen with reference to FIG. 13, in the exemplary embodiment illustrated, the bearing sleeve 19b is made from plastically deformable and accordingly energy-absorbing material. In the event of an appropriate crash loading, in which a relative movement occurs between housing side part 5b and winding shaft 13b, the driver pin 18b digs into the plastically deformable material of the bearing sleeve 19b such that corresponding kinetic energy is converted into deformation energy. The bearing sleeve 19b in conjunction with the driver pin 18b therefore serves as an energy absorption means.

1. Loading space for a motor vehicle, with a protective device which comprises a flexible sheetlike structure for holding back a load and has a dimensionally stable housing unit which is held releasably in mounts on the loading space side, comprising means for transferring the housing unit into a securing position, which is connected with a form fit to the mounts on the loading space side, as a function of a tensile or flexural loading acting on the sheetlike structure.

2. Loading space according to claim 1, wherein the transferring means have, in the region of the mounts on the loading space side, profiled guide structures which, starting from an unloaded fastening position of the housing unit, are set in the direction of a deflection movement of the housing unit during a tensile or flexural loading on the sheetlike structure, and wherein guide elements are provided on the housing unit and are designed in a manner corresponding to the profiled guide structures such that, upon a deflection movement of the housing unit, they enter the profiled guide structures and engage behind the latter with a form fit along an axis of rotation of a winding shaft for winding up and unwinding the sheetlike structure.

3. Loading space according to claim 2, wherein the profiled guide structures are configured as slotted-guide mechanisms which are set in the vertical direction of the vehicle, and in that the guide elements are designed as guide pins, which protrude along the axis of rotation of the winding shaft, are provided with a thickened head and the diameter of which is matched to the slotted-guide mechanisms in such a manner that the guide pins are displaced in a sliding manner in the slotted-guide mechanisms.

4. Loading space according to claim 1, wherein the means for transferring the housing unit into a form-fitting securing position comprise at least one securing element, which is assigned to the housing unit and is arranged removably with respect to the housing unit between a locked and an unlocked position, the securing element being operatively connected via a constrained coupling mechanism to a winding shaft on which the flexible sheetlike structure is held in a manner such that it can be wound up and unwound, in such a manner that, upon a rotational movement of the winding shaft, the securing element is transferred into a locked position or an unlocked position as a function of the direction of rotation.

5. Loading space according to claim 4, in that wherein the constrained coupling mechanism comprises a movement transmission element which is coupled to the rotational movement of the winding shaft and is provided with a constrained guide which acts on the securing element in such a manner that, upon a rotational movement of the winding shaft, the securing element is transferred into said locked position or said unlocked position.

6. Loading space according to claim 5, wherein the securing element can be rotated by means of the constrained guide in a limited manner between said locked position and said unlocked position about an angle of rotation unequal to a half or a full revolution.

7. Loading space according to claim 5, wherein the constrained guide comprises a helical guide groove in which a slotted-guide pin connected in a rotationally fixed manner to the securing element is guided.

8. Loading space according to claim 5, wherein the constrained guide comprises a driver disk which is rotationally fixed to the winding shaft and acts non-positively or with a form fit on a driver pin connected in a rotationally fixed manner to the securing element.

9. Loading space according to claim 8, wherein the securing element is assigned energy absorption means which act in an energy-converting manner between securing element and winding shaft in the event of loadings caused by a vehicle impact.

10. Loading space according to claim 9, wherein the energy absorption means comprise at least one plastically deformable buffer element which becomes effective during a relative movement between securing element and winding shaft.

11. Protective device for a motor vehicle interior loading space, comprising a flexible sheetlike structure for holding back a load and a dimensionally stable housing unit configured to mount releasably on at least one side of the loading space, and means for transferring the housing unit into a securing position, connected with a form fit to mounts on said at least one side, as a function of a tensile or flexural loading on the sheetlike structure.
